(19) United States
(12) Patent Application Publication
(10) Pub. No.: US 2013/0199078 A1
(43) Pub. Date: Aug. 8, 2013

(54) LURE

(71) Applicant: Vesa Kaariainen, Mikkeli (FI)

(72) Inventor: Vesa Kaariainen, Mikkeli (FI)

(21) Appl. No.: 13/758,127

(22) Filed: Feb. 4, 2013

(30) Foreign Application Priority Data
Feb. 8, 2012 (FI) FI U20124028

(51) Int. Cl. A01K 85/14

(52) U.S. Cl. CPC A01K 85/14
USPC 43/42.24

(57) ABSTRACT

The invention relates to a lure, which includes plate pieces attached to each other by means of a flexible joint. In one plate piece there is an attachment point for a line, and in another plate piece there is a hook. In connection with the joint, a stop is arranged to limit the mutual movement between the plate pieces.

### CROSS REFERENCE TO RELATED APPLICATION

This application claims priority from Finnish application no. FI U20124028 filed Feb. 8, 2012.

### TECHNICAL FIELD

The present invention relates to a lure, which includes plate pieces, which are attached to each other by means of a flexible joint, and in one plate piece there is an attachment point for a line, and in another plate piece there is a hook.

### BACKGROUND OF THE INVENTION

One known lure is disclosed in U.S. Pat. No. 2,037,310. In the lure there are two plate pieces attached to each other by means of a flexible joint. The joint permits the plate pieces to turn relative to each other, in order to alter the swimming motion. In the front plate piece there is an attachment point for a line. Correspondingly, a hook is attached to the rear plate piece, on which a predatory fish becomes caught when it bites the lure.

In the known lure, the plate pieces are bent transversely, so that when the lure is pulled through the water the lure swerves upwards and downwards. The swimming motion in question differs disturbingly from the swimming motion of a fish that is the prey of a predatory fish. In addition, due to the flexible joint, the lure, and particularly its hook can become caught on the line when casting the lure, for example, when used with a spinning rod. In other words, the matter concerns a trolling lure.

### SUMMARY OF THE INVENTION

The invention is intended to create a new type of lure, which has a more diverse swimming motion than previously and which can also be used reliably as a spinning lure. The characteristic features of the present invention are stated in the accompanying Claims. The construction of the lure according to the invention is not only simple, but also new and unexpected. By means of a surprising construction, a random and attractive swimming motion is induced in the lure while nevertheless also permitting casting. In addition, the lure's swimming motion can be adjusted finely, which further increases the lure's effectiveness in fishing.

In the following, the invention is described in detail with reference to the accompanying drawings depicting some embodiments of the invention, in which

### BRIEF DESCRIPTION OF THE DRAWINGS

In the drawings:

FIG. 1a shows the lure according to the invention,

FIG. 1b shows a top view of the plate pieces of the lure according to the invention, during the initial stage of manufacture,

FIG. 1c shows a second lure according to the invention, in the manner of FIG. 1a,

FIG. 1d shows the plate pieces of the lure according to FIG. 1c, in the next stage of manufacture,

FIG. 1e shows the plate pieces of FIG. 1c, attached to each other by means of a flexible joint,

FIG. 1f shows a second position of the lure according to FIG. 1a,

FIG. 2a shows a third position of the lure according to FIG. 1a,

FIG. 2b shows a fourth position of the lure according to FIG. 1a,

FIG. 2c shows a fifth position of the lure according to FIG. 1a,

FIG. 3a shows the real appearance of the lure according to the invention, and

FIG. 3b shows the real appearance of the second lure according to the invention, seen from the opposite side to that in FIG. 3a.

### DETAILED DESCRIPTION OF THE INVENTION

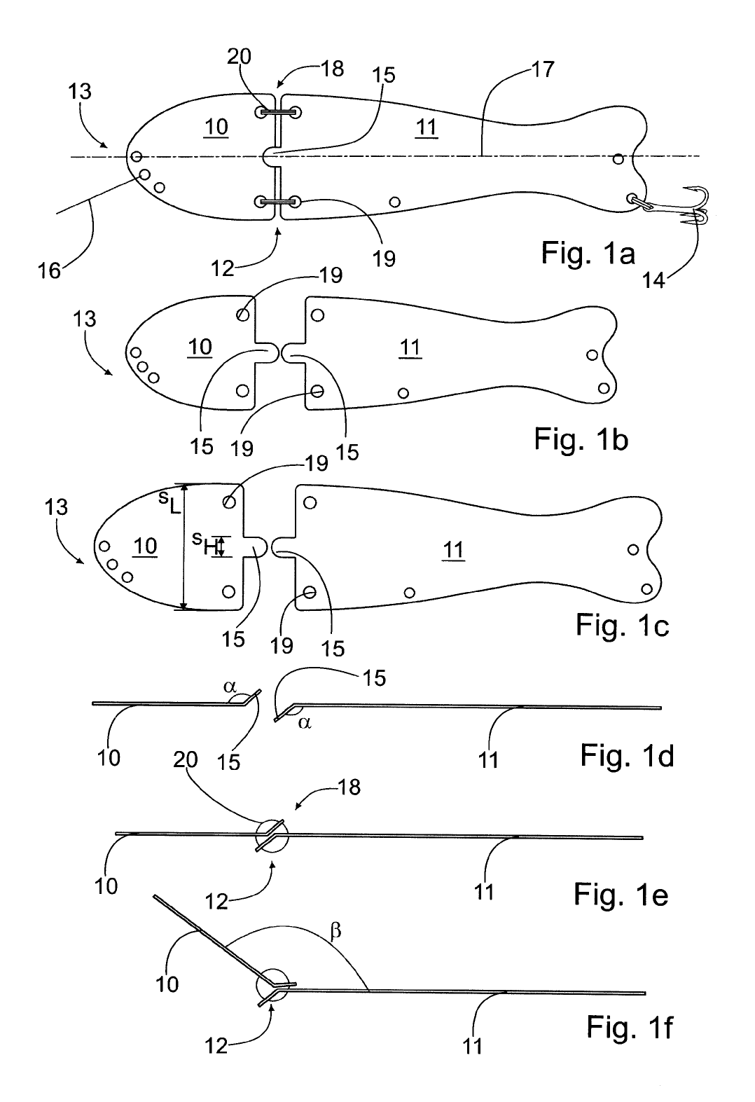

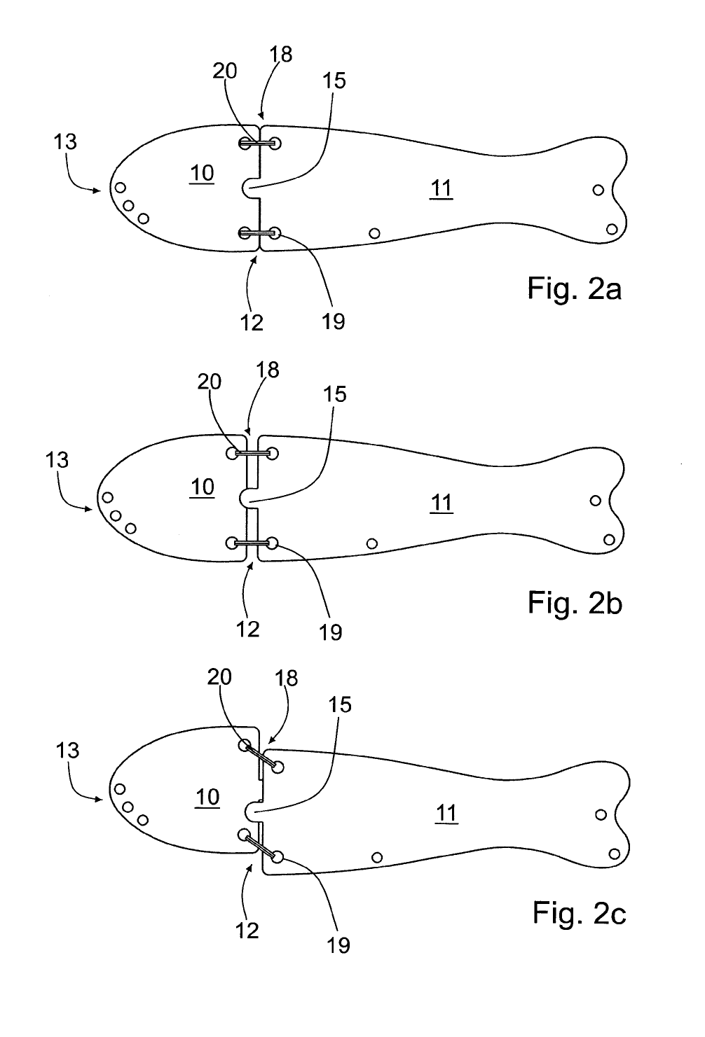

Referring now to the drawings in detail, FIG. 1 shows the lure according to the invention, which is intended for fishing. The lure includes plate pieces 10 and 11, which are attached to each other by means of a flexible joint 12. The joint in question permits the mutual movement of the plate pieces. In the lure according to the invention, there are preferably two plate pieces, the front one of which being smaller than the rear one, more specifically, the front is shorter than the rear. In addition, the lure is preferably shaped like a prey fish, thus avoiding an effect that would scare away a predator fish. In one plate piece 10, there is an attachment point 13 for a line 16. Correspondingly, in the second plate piece 11 there is a hook 14, which will catch a predator fish when it bites the lure. According to the invention, a stop 15, which is set to limit the mutual movement of the plate pieces 10 and 11, is arranged in connection with the joint 12. In the invention, the stop is arranged in such a way as to prevent particularly the doubling over of the plate pieces relative to each other. This prevents so-called jack-knifing, in which the hook can become entangled with the line during casting. In such a situation the cast must be made again, when the predator fish may vanish from the place. This will lose the advantage brought by the first cast and otherwise too lead to a low probability of a successful cast. Thanks to the stop, jack-knifing can be avoided, so that fishing remains pleasant, with a high probability of a successful cast. Thus the lure is preferably used as a spinning lure.

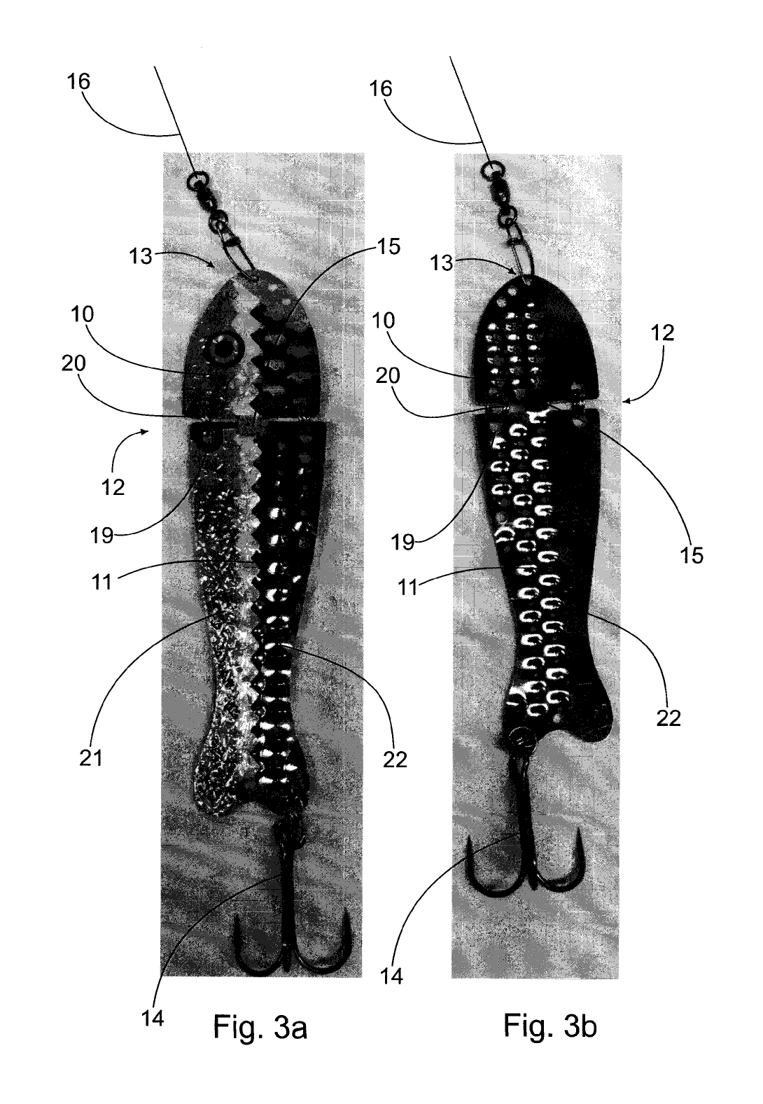

In practice, a line 16 from a piece of fishing tackle, such as a reel attached to a rod, is attached to the front plate piece 10. Correspondingly, a hook 14 (also FIGS. 3a and 3b) is attached to the rear plate piece. The size and shape of the hook may vary in different applications.

The prevention of jack-knifing is the real task of the stop. However, the mutual movement of the plate pieces is important in terms of the operation of the lure. In other words, the plate pieces must have a sufficient amount of movement in order to achieve an attractive swimming motion. Thus the width s_{H} of the stop 15 is 10-50%, preferably 20-40% of the width s_{L} of the plate pieces 10 and 11 (FIG. 1c). The plate pieces can then also move laterally and crosswise, when an unexpected swimming motion will be retained. The lure can even change the direction in which it rotates.

Correspondingly, the doubling over of the plate pieces against each other is significant. In other words, the plate pieces must be allowed to turn sufficiently. Thus, the angle α between the stop 15 and the plate piece 10, 11 is 120-170 , preferably 130-150 (FIG. 1d). The stops and their angles are preferably similar in both plate pieces. If necessary, the angle can be easily changed, when the swimming of the lure can be made more unexpected and the operation of the lure can be adjusted. By increasing the angle α, the limitation can be made tight, when the motion of the lure will become more relaxed, because the plate pieces can only turn to a small extent.

The stop can be formed in different ways. For example, the stop can be made as a separate piece, which is attached to one or other of the plate pieces. The stop can be, for example, a Y-shaped piece of plastic, which is glued to the plate piece. Separate stops can also be attached to each plate piece. The stop 15 is preferably formed from the base material of the plate pieces 10 and 11. In other words, each plate piece has its own stop, which is bent in different directions to each other. FIGS. 1b and 1c show the plate blanks, from which the lure is manufactured. In this case, the plate pieces are cut by laser from thin sheet metal and the stops 15 are formed at the same time. After cutting, the stop is bent and the plate pieces are attached to each other. The metal plate is preferably chrome-plated brass sheet, in which protrusions 22 are stamped to make it more attractive (FIGS. 3a and 3b). Naturally, there will be a depression on the opposite side of the lure to the protrusion. In addition, taping can be added to increase attractiveness. Painting can also be used. Particularly if depressions, protrusions, and/or other shaping has been made in the plate piece to increase attractiveness, painting will be easy to implement. On a flat surface, even tape will remain securely in place. In addition, reflective taping, for example, can be arranged on a painted plate piece. Besides laser cutting, the plate piece can be stamped out of a sheet material.

An attractive swimming motion can be achieved by means of a multi-part lure. In addition to this, there are preferably several attachment points 13, at least some of which are arranged to one side of the longitudinal centre line 17 of the lure. The lure can then also be made to rotate around its longitudinal axis, in addition to which the lure will unexpectedly change its direction, thanks to the flexible joint. In other words, the lure will both rotate and simultaneously change its direction, which increases its fishing effect. The swimming motion of the lure is surprisingly retained, despite the speed at which it is pulled.

The lure according to the invention includes two plate pieces 10 and 11, between which a joint 12 permitting the mutual movement of the plate pieces 10 and 11 is arranged. Thus, the mutual attitude and/or position of the plate pieces changes during fishing, which makes the lure's swimming motion unexpected, thus increasing its fishing effect. If the line is attached to one side of the centre line of the lure, the lure will have a mostly rotational swimming motion, but thanks to the new type of construction the rotating motion can suddenly change. The change is random and demands no action by the user, such as a change in pulling speed.

The joint can be made in different ways. The joint 12 is preferably formed from ring elements 18, in which case sufficient sensitivity will be achieved while at the same time the construction will be simple and the pulling resistance low. There are attachment openings 19 in the plate pieces 10 and 11 for the ring elements 18. In the embodiments shown, the ring elements 18 are formed of two detachably attached rings 20. The properties of the lure can then be influenced by changing the rings. In particular, the size of the rings affects the lure's susceptibility to changing its swimming motion. Another essential factor is the tolerance provided by the rings. In this case, the rings are larger than the attachment openings and, when pulled, the plate pieces are separate from each other, so that the joint is responsive. The ring elements are arranged to permit mutual movement between the plate pieces in at least one direction. Thus, for example, the changes caused by the prevailing flows cause the mutual attitude of the plate pieces to change unexpectedly, thus achieving a completely new type of swimming motion. The lure darts unexpectedly is a different direction, usually in the opposite direction. Such a swimming motion looks exactly like the unexpected change in direction of a real fish. In addition, the plate pieces are arranged to form a symmetrical shape relative to the longitudinal centre line of the lure. Adjustment of the swimming motion of the lure is achieved by arranging several attachment points in the front plate piece. The centre line 17 is shown by a dotted broken line in FIG. 1a.

The desired swimming motion is achieved, even though the plate pieces are mainly planar. However, at the same time the manufacture of the lure remains simple. The plate pieces are preferably manufactured from metal, so that the lure will have a sufficient mass for casting. Reflective tape 21 can be glued on one or both sides of the lure (FIG. 3a). Particularly the refection of rays of light is improved by means of the taping. Various types of patterns and colours can be selected for the reflective tapes. The size and shape of the reflective tape can also be altered. Painting too can be used. Painting can be used to achieve diverse colourings easily and quickly and reflective paint too can be used.

The thickness of the plate pieces in the lure in question is about one millimeter. The size of the lure can be changed while keeping the ratios between the dimensions essentially the same. The length of the lure of FIG. 3a is about 110 mm and the length of the lure of FIG. 3b is about 130 mm. The rear plate piece of the longer lure is more elongated than in the shorter lure, which for its part affects the swimming motion. In practice, the swimming motion of the longer lure is slightly more relaxed, thus resembling more a hunting predatory fish than a prey fish. By means of suitable dimensioning, one type of front piece can be attached to two or more different types of rear piece. In addition, through its own movement the lure creates reflections that will attract the predator fish being fished for.

The lure according to the invention can have one or more hooks 14. The unique swimming motion of the lure gives it a good fishing effect. There can also be more than one hook, for example, a hook can be attached to the rear plate piece, in which there is a hole ready in the middle of the plate piece. A hook can also be attached to the front plate piece.

In addition to the number and positioning of the attachment points for the line, the motion of the lure is substantially affected by the movement of the ring-like attachments, both parallel to the plate pieces and also slightly laterally. These movements substantially affect the irregular swimming of the lure. The movements do not, however, affect the up-and-down movement of the lure. The lure according to the invention is also characterized by a comprehensive adjustment possibility. The plate-like lure can be made to repeat a movement from above downwards, which known lures lack. The lure according to the invention also alters its swimming motion, which property is entirely lacking in known lures. This alteration is very good in activating predatory fish. The shape and swimming motion of the lure additionally reduce the pulling resistance, which is considerably lower than that of other lures in the same size class. The lure imitates a hunting predatory fish in order to attract other predatory fish to the place. In tests, the lure has been seen to have a fishing effect especially on pike and pike-perch. The stops according to the invention prevent the rear plate piece from so-called going-over. In other words, with the aid of the stop the turning of the plate pieces can be limited, thus avoiding the hook becoming entangled with the line. Thus, the lure can be used as a spinning lure. Further, the taping, for example, and the particular unexpected swimming motion give the lure a good fishing effect.

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.

What is claimed is:

1. A lure, which includes plate pieces, which are attached to each other by means of a flexible joint, and in one plate piece there is an attachment point for a line, and in another plate piece there is a hook, characterized in that in connection with the joint a stop is arranged, which is arranged to limit the mutual movement between the plate pieces.

2. A lure according to claim 1, characterized in that the width s_{H} of the stop is 10-50%, of the width s_{L} of the plate piece.

3. A lure according to claim 1, characterized in that the angle α between the stop and the plate piece is 120-170.

4. A lure according to claim 1, characterized in that the plate is formed from the basic material of the plate pieces.

5. A lure according to claim 1, characterized in that the stop is arranged in each plate pieces.

6. A lure according to claim 1, characterized in that the lure is formed of two plate pieces.

7. A lure according to claim 1, characterized in that there are several attachment points and at least some of the attachment points are arranged to one side of the longitudinal centre line of the lure.

8. A lure according to claim 1, characterized in that, in the direction of travel of the lure, the second plate piece is at least twice the length of the first plate piece.

9. A lure according to claim 1, characterized in that protrusions are formed in the base material of each plate piece.

10. A lure according to claim 1, characterized in that each plate piece includes reflective tape.

11. A lure according to claim 1, characterized in that each plate piece includes painting.

12. A lure according to claim 1, characterized in that the plate pieces are of sheet metal with a thickness of 0.5-1.5 mm.

13. A lure according to claim 1, characterized in that the lure is a spinning lure.

14. A lure according to claim 1, characterized in that the length of the lure is 100-140 mm.

15. A lure according to claim 1, characterized in that the shape of the lure corresponds to the shape of a predatory fish.
